(19) United States
(12) Patent Application Publication
(10) Pub. No.: US 2015/0118449 A1
(43) Pub. Date: Apr. 30, 2015

(54) DOCUMENT OF VALUE, A METHOD OF PRODUCING IT AND SHEET CARRYING DOCUMENTS VALUE

(71) Applicant: DE LA RUE INTERNATIONAL LIMITED, Hampshire (GB)

(72) Inventors: Matthew Sugdon, Hampshire (GB); Stephen Banister Green, Southampton (GB)

(21) Appl. No.: 14/399,280

(22) PCT Filed: May 1, 2013
(86) PCT No.: PCT/GB2013/051118

§ 371 Date: Nov. 6, 2014

Related U.S. Application Data
(60) Provisional application No. 61/645,192, filed on May 10, 2012.

(30) Foreign Application Priority Data
May 10, 2012 (GB) 1208130.3

(51) Int. Cl. B42D 15/00

(52) U.S. Cl. CPC B42D 15/0093
USPC 428/195.1; 83/13; 83/53; 219/121.72

(57) ABSTRACT

A method of producing a document of value, the method including providing a single lamina or multi-laminate sheet carrying data relating to one or more documents of value; selecting the shape of at least part of the edge of the or each document using the data relating to the document; and operating a cutting tool to cut out the or each security document from the sheet by cutting along the edge of the or each security document such that the at least part of the edge has the selected shape.

The invention relates to a method of producing a document of value such as an ID card, driving licence or the like.

Currently, such driving licences, ID cards and similar documents of value are manufactured from pre-laminated sheets, typically of polymer, but also layers of polymer and paper. Single layer sheets could also be used. The sheets are typically pre-prepared with one or more printed security indicia patterns and then personalized data relating to individual cards is provided in laterally spaced areas on the sheet corresponding to individual cards. The individual cards are then punched out of the laminate using a male/female hardened steel die tool. These die tools are very expensive but practical because, since the dimensional requirements of ID cards at least are laid out in international standards such as ISO 7810, the shape of the cards is the same.

More recently, laser cutting has been proposed in place of the use of dies as, for example, mentioned in U.S. Pat. No. 8,087,772.

With the proliferation of different types of document of value, particularly ID cards, driving licences and similar such documents, there is a continuing need to achieve greater efficiency in the production of such security documents particularly because requests to manufacturers for different security documents are received in a random fashion.

In accordance with a first aspect of the present invention, a method of producing documents of value comprises providing a single lamina or multi-laminate sheet carrying data relating to a plurality of documents of value laterally spaced apart on the same sheet; selecting the shape of at least part of the edge of each document using the said data relating to the said document; and operating a cutting tool to cut out each document of value from the sheet by cutting along the edge of each document of value such that said at least part of the edge has the selected shape.

We have realised that one of the problems with achieving efficient production is due to the fact that there is an increasing trend for differently shaped documents of value for both aesthetic and security reasons. Typically, therefore, in the past, particularly where multiple documents of value are produced from a single sheet, it is necessary to assemble together requests for multiple documents of value of the same type so that the same tool can be used to cut them out from the sheet.

In contrast, with the present invention, we have realized that it is possible to produce differently shaped documents of value together on the same single sheet by using a cutting tool, such as a laser, which can cut out each document in a shape determined by reference to the data relating to the document.

Various methods may be implemented to select the shape of at least part of the edge of the document. One approach is to provide a reading device such as a camera, barcode reader, magnetic reader, or a contactless or contact electronic chip reader or the like, for reading the data provided on the sheet in the location of the document in question and then accessing a suitable memory or store in which edge shape information corresponding to each type of data can be obtained. Alternatively, the data provided on the or each document can also be stored separately in such a manner than the production system will be able automatically to associate that data with the document in question and thereby obtain the required edge shape information.

Typically, security indicia are also provided on each document of value, the security indicia typically being a security pattern which may be provided as an all over pattern on the sheet or repeated in the area of each security document. Examples include guilloche patterns graphics, text or symbols which are to be common to all, or at least a number of, the documents so produced. For example, the security indicia may simply be in the form of a background pattern to improve the appearance of the document. The security indicia could include security features such as fine line designs and could be applied using coloured or security inks, such as UV or IR responsive inks, to increase the difficulty of forgery.

Alternatively, the area of the sheet corresponding to each document of value could be provided with its own security indicia, different from other areas.

The security indicia can be printed on the sheet by any conventional printing method.

The data relating to the or each document of value may relate to the type of document. Examples of different types of document of value comprise ID cards, driving licenses, credit cards, debit cards, certificates of authenticity, and passports. The invention could also be applied to banknotes. In addition, or alternatively, the data relating to the document of value may relate to the holder of the security document, for example nationality, age, country of residence, biometric data and the like.

The data relating to the document of value may be provided as printed data, or machine readable data, for example in a RFID chip or as a magnetic code, for example in a magnetic stripe. Where the data is provided as printed data, it is preferably readable to the naked eye. This helps in verifying the document in use.

There are many different shapes which may be imparted to the edge of the document of value. For example, the documents may have different corner shapes. In other examples, edge indents may be provided which are differently shaped between different security documents or differently positioned or both. In further examples, one type of security document may have an edge indent while another does not. Furthermore, the overall shape of the documents could differ, for example having different polygonal shapes.

The cutting tool is typically one of a laser, water jet, air jet or knife, preferably a robot-controlled knife.

The sheet can be a single lamina of, for example, plastics or paper, or alternatively a multi-laminate sheet made up of plastics laminae or a mixture of plastics and paper.

Furthermore, either prior to or after the step of operating the cutting tool, the documents or sheet can be provided on one or both sides with further laminae, typically protective plastics material, normally transparent, in a conventional manner. To enable this lamination, adhesives are typically applied to both the sheet and/or the protective plastic material. In some cases an adhesive is applied to the sheet or the protective plastic material prior to a printing step such that some or all of the security indicia may be applied to the adhesive rather then directly onto the protective plastic material or the sheet.

Although the invention has been described primarily in connection with the production of documents of value such as ID cards and driving licences, the invention is applicable more generally to other documents of value such as debit cards, credit cards, certificates of authentication, passports and banknotes.

Typically, the invention will be implemented under computer control. In one example, all steps could be carried out in-line with sheets being provided, for example printed, with security indicia and the said data, the sheets then being fed to a cutting machine. In other examples, the sheets could be provided in advance with security indicia and then supplied to a separate machine, possibly in another country, for provision of said data relating to the security documents, the sheets then being cut by a machine in line with the data providing machine or again the cutting machine could be separate and in yet a further country.

The first aspect of the invention leads to the possibility of implementing a new generation of documents of value. Thus, according to a second aspect of the invention, a document of value comprises a substrate carrying data relating to the document of value, the edge of the substrate being formed with one or more notches or indents shaped and/or located in accordance with said data.

Some examples of methods and apparatus for performing those methods according to the invention will now be described with reference to the accompanying drawings, in which:

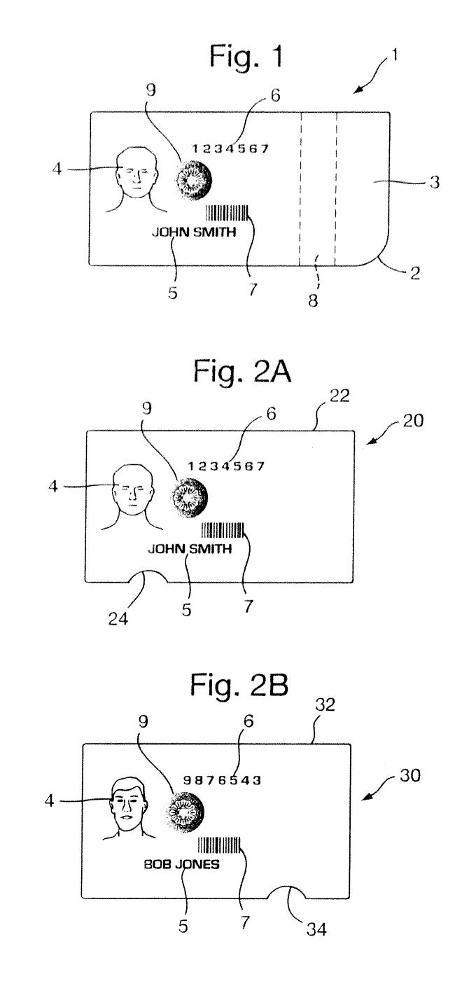

FIG. 1 is a schematic plan of an example of an ID card produced using an example of a method according to the invention;

FIGS. 2A and 2B illustrate schematically further examples of ID cards produced using an example of the invention;

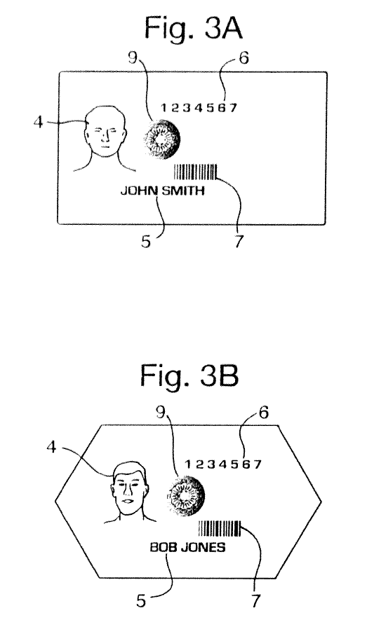

FIGS. 3A and 3B are similar to FIGS. 2A and 2B respectively but illustrating further shapes for ID cards;

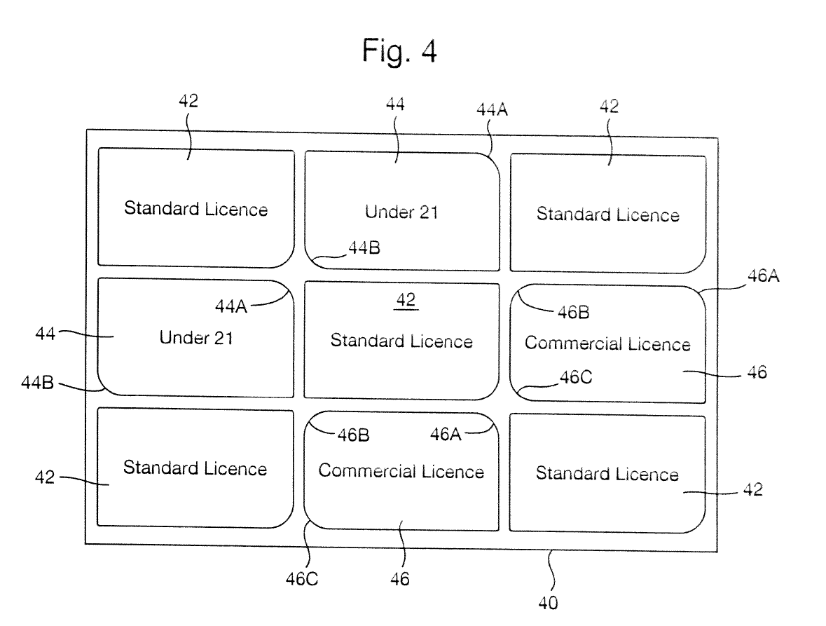

FIG. 4 illustrates the shapes of a number of ID cards produced on a single sheet by a method according to the invention;

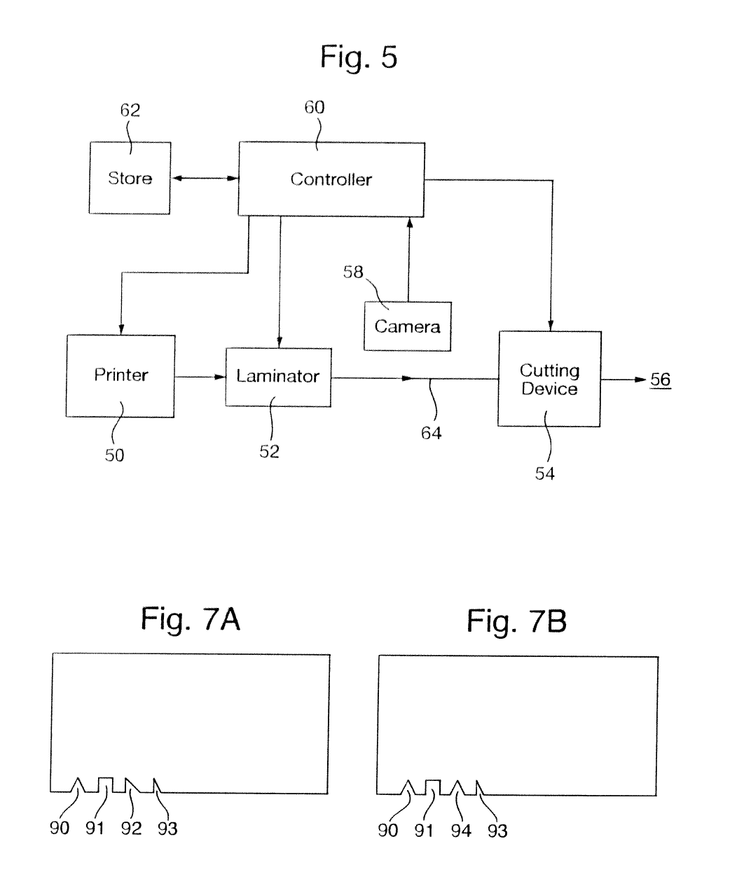

FIG. 5 is a schematic block diagram of an apparatus for carrying out an example of a method according to the invention;

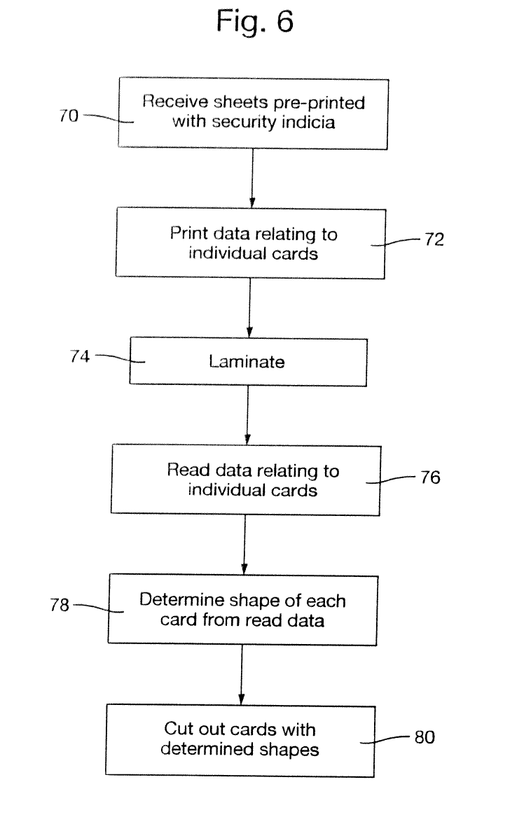

FIG. 6 is a flow diagram illustrating operation of the apparatus shown in FIG. 5; and,

FIGS. 7a and 7b illustrate two ID cards with different notch patterns along their edges.

The ID card 1 illustrated in FIG. 1 is intended to be used as a “standard licence” for adults over 21. The important aspect of the card illustrated is that although it has a generally rectangular form, the lower right hand corner 2 of the edge of the card 3 is rounded in contrast to the relatively sharp form of the other three corners. This rounding gives the card a characteristic shape which is easily recognizable when the card is inspected and allows the card to be distinguished from other driving licences as will be explained below.

The remainder of the driving licence can have any of the usual features provided on such security documents relating to the security document and the security document holder. This data can include a photo image 4 of the holder of the licence, the holder's name 5 typically embossed into or printed on the substrate, a serial number 6 printed on the substrate, and a barcode 7 containing personalized information such as the serial number, holder's name and the like. A magnetic stripe 8 is optionally provided which again can encode personalized data or data defining the fact that the document is a driving licence.

In addition, the driving licence carries conventional security indicia such as a guilloche pattern 9.

Typically, the card 1 is in the form of a multi-laminate sheet. Each sheet could comprise a polymeric or plastics material laminated together or alternatively one or more of the sheets could be made of paper, Teslin or the like. For an identification card made using Teslin typical security indicia would be printed onto a core material or substrate such as Teslin™ manufactured by PPG Industries which is then laminated between cover layers of a plastics material such as polyester. Teslin™ is a mixture of polypropylene and polyethylene with silica. Typical Teslin™ grades are up to 70% air by volume and so are light, flexible and have high porosity which makes them particularly suitable for use as a substrate for printing and laminating. In the case where the Teslin or other substrate is to be laminated to a further plastic layer on one or both sides then a first adhesive layer is applied preferably in at least partially molten form, and preferably by extrusion. In the case where the substrate comprises a porous material, such as Teslin(tm) or even paper, such application techniques result in a particularly strong bond between the substrate and the adhesive layer, since the adhesive material permeates a distance into the substrate microstructure before setting. Security indicia can be applied to the adhesive layer in addition or as an alternative to being applied to the base sheet.

The information shown in FIG. 1 is generally visually readable to the naked eye although one or more of the items could be provided in a covert manner, for example being readable in response to infrared radiation. In addition, instead of or in addition to the magnetic stripe 8, information could be provided in a RFID chip embedded into the card.

In other examples, the card is made from a single lamina such as paper or plastics although this would then typically be provided with one or more transparent protective films on each side.

In the preferred process, the card is formed from a sheet of Teslin security printed with patterns such as the guilloche pattern 9 using offset lithography.

FIGS. 2A and 2B illustrate further examples of driving licence ID cards which essentially have the same format as the driving licence in FIG. 1 but with different edge shapes. As can be seen, the card 20 has an edge 22 with square corners but with a semicircular indent or notch 24 located in the lower edge part to the left hand side in the region of the photo image 4.

The driving licence 30 shown in Figure 2B has the same form as the driving licence 20 except that its edge 32 has a semicircular indent 34 along the lower edge towards the right hand side.

The presence of the indents or notches 24,34 like the rounded corner 2 in FIG. 1 provides an anti-counterfeit feature since it is difficult for counterfeiters to copy these features. In addition, however, the indents 24,34 provide an inspector with an easy way of differentiating between the two types of driving licence. This differentiation may be on the basis of different states in the US for which the driving licences are valid. Thus, the driving licence of FIG. 2A could be issued in New York state (and all driving licences would have the shape shown in FIG. 2A in that state) while the driving licence of FIG. 2B is issued for the state of California. Other reasons why differently positioned indents 24,34 might be provided are to indicate different age groups for the holders (under 21 and over 21 respectively), different nationalities for the holders, etc.

FIGS. 3A and 3B illustrate further examples in which driving licences, i.e. ID cards, of the same type, are distinguished by having different polygonal shapes. The driving licence of FIG. 3A is rectangular and the driving licence of FIG. 3B is hexagonal. Again, this differentiation could be on the basis of any of the reasons given above in relation to FIG. 2.

During production of the driving licences, the inventive method allows more than one driving licence to be provided on a single sheet or substrate even though the driving licences have different shapes. This is illustrated in FIG. 4 in which a single or multi-laminate sheet 40 is used to produce nine different driving licences, in this case of three types, namely a Standard Licence, a licence for Under 21 holders, and a Commercial Licence. In FIG. 4, all printing and other information has been omitted for clarity and solely the shapes of the different licences are illustrated. Thus, the Standard Licences 42 have the same shape as shown in FIG. 1. The Under 21 licences 44 have two rounded corners 44A, 44B, the corners being diagonally opposite one another. Finally, two Commercial Licences 46 are provided having three rounded corners each 46A-46C.

In a further embodiment, the shape of the edge could be used as a mechanism to carry personilisation data which is unique to the document holder such as date of birth or biometric information. For example this could be done by cutting different notch patterns into each document or by varying the profile of one or more of the edges. The use of multiple notches or variable edge profiles increases the amount of information which can be placed on one document, and the security of the document will be increased as the meaning of the multiple notches or variable profile will not be apparent to an observer unless they have knowledge of the manner in which the notches or profiles are selected in order to represent the data item. In a simple embodiment for representing numerical data such as date of birth or serial number a different notch shape could be used for each number. However it is preferable that the data is first encoded using conventional means and then the encoded data is assigned a pattern of notches.

Each document within a series may have multiple notches 90-93,90,91,94,93 as shown in FIGS. 7a and 7b respectively. The data at each notch can be varied by changing the shape of the notch so that each member of the series has a different pattern of notches, for example relating to the holder of the document. The “shape” of a notch refers to its geometrical outline. The shape of the notches may differ from one another by having a different number or configuration of sides, different lengths of the sides relative to one another, a different number, arrangement or angles of corners, or at least a different aspect ratio. In the case of the cards in FIGS. 7a and 7b, the triangular notch 92 of FIG. 7a has been replaced by a different triangular notch 94 while the other notches are unchanged.

The different notch shapes can be readily recognised by imaging equipment (indeed the different notch shapes will generally be apparent to the human eye), enabling the data item to be decoded with a high degree of accuracy. In addition, the number of different notch shapes which can be individually recognised and distinguished from one another is virtually limitless, enabling a very high density of additional information to be encoded into the document of value.

In addition to the shape, the “orientation” of a notch could also be varied. The orientation refers to its rotational position about an axis normal to the surface of the security document through which the notch is made. Different orientations can also be achieved by reflecting the outline of the notch about an axis within the plane of the document. For example, a first elongate rectangular notch arranged parallel to an edge of the document is considered to have a different orientation from a second elongate rectangular notch of the same aspect ratio having its long axis making a non-zero angle with the same edge of the document. By arranging notches to make up an encoded data item to have different orientations in this way, a substantial volume of data can be encoded into the document of value. Of course, in order that the different orientations are recognisable, the notches should not have a highly symmetric shape. In particular, notches having full circular symmetry will not be suitable for this purpose.

In addition, or alternatively, notches in different locations could be used.

The encoded data item can be represented using different shapes of the notches, different orientations (with all notches being of the same shape), or different locations or a combination of these approaches.

The data to be encoded on the edge of the document can be converted into a corresponding arrangement of notch shapes and/or orientations in various ways. For example the data item is first preferable encoded and this encoded date could be linked in a database to a randomly selected arrangement of notch shapes/orientations which should be applied to a data item in order to represent that encoded data item. Alternatively, a predefined algorithm could be used to convert the data item into shapes or orientations.

We will now describe apparatus and a method according to an example of the invention for producing the driving licences shown in FIG. 4.

The apparatus shown in FIG. 5 comprises a printer 50, such as a laser printer, inkjet printer or a dye sublimation printing device adapted to print data relating to individual ID cards including personalized data onto sheets as will be described further below. The printed sheets are then fed to a laminator 52 which laminates clear plastic sheets on both sides of the printed sheet and then the laminated sheets are fed to a cutting device 54, typically a laser cutter. The laser cutter cuts up the sheet into individual cards which are then fed to a stacking location 56.

A camera 58 is located above the feed path from the laminator 52 to the cutting device 54 in order to read information printed on the sheets. A controller such as suitably programmed computer 60 is connected to the printer 50, laminator 52 and cutting device 54 in order to control those devices and receives information from the camera 58. The controller 60 is also connected to a data store 62 storing edge definition information.

In use, pre-printed sheets are provided (step 70) to the printer 50. These are typically A4 size and are pre-printed with security indicia. Typically, an overall security printed pattern is provided although individual security indicia could be provided corresponding to the different driving licences which are to be formed. The sheets may also include magnetic strips, RFID chips, holograms and other conventional security features.

The individual sheets are then supplied to the printer 50 either manually or automatically and, under the control of the controller 60, data relating to the specific driving licences is then printed (step 72) in the correct laterally spaced locations onto the sheet. These locations are indicated in FIG. 4 with respect to the sheet 40. The information that is printed will be data relating to the holder of the driving licence as indicated by references 4-7 in FIG. 1. Of course, if a magnetic stripe 8 is provided then a separate recording device will be provided to record the appropriate information on the magnetic stripe.

The fully printed sheet is then fed to the laminator 52 in which transparent plastic sheets are laminated on either side to provide protection (step 74). This shields the printed data within, from damage which could otherwise occur during handling. The protective layer is a plastics material such as PET, PVC, polycarbonate, PBT or blends of the previous materials. This is typically an adhesive lamination process and preferably adhesive would have been pre-applied to both the core sheet and the protective plastic laminates.

The protected sheet is then conveyed on a suitable conveyor along a path 64 from the laminator 52 to the cutting device 54. As it passes along the path 64, the camera 58 reads the printed information necessary to enable the controller 60 to determine what shape the edge of each card should be (step 76). Thus, following printing, as shown in Figure 4, each region of the sheet 40 corresponding to a driving licence will be provided with information defining the type of licence concerned and this information can be read by the camera 58. In other embodiments, a barcode reader could be provided to read any barcode 7 appearing on the licence, the barcode defining appropriate information, for example the State in which the driving licence is issued, the type of licence, etc.

The controller 60 then uses the read information to access a store 62 which contains information defining the shape of the edge of the card corresponding to each type of read information.

In the case of the Figure 4 example, therefore, the store 62 will define three different edge shapes for cards corresponding to the Standard Licence 42, Under 21 licence 44 and Commercial Licence 46 respectively. The controller 60 determines which type of licence is to be provided in each area of the sheet 40 and then determines the appropriate shape from the store 62 (step 78).

The sheet is then fed onto the cutting device 54 which is controlled by the controller 60 to cause the laser beam to cut around the edge of each licence on the sheet 40 in the shape defined for that licence as obtained from the store 62 (step 80).

The individual cut driving licences are then fed to the stacking location 56 for distribution.

In another example, not shown, the camera 58 could be omitted, and the controller 60 would receive, from a source used to provide the data to be printed, information defining the type and location of each card on the sheet and thus obtain the required edge shape information from the store 62.

Typically documents produced from the current invention are provided with a number of security elements for checking the authenticity of the document. These may include RFID chips, holographic films, optically variable elements (such as colour-changing inks), security inks (such as IR and UV visible inks) and other printed data. Some such security elements may themselves contain personalisation information identifying the owner of the document (e.g. data giving the owner's name, a photograph or biometric data), whereas other security elements may be provided to prevent other data being manipulated (for example a holographic film overlaying printed data). These security elements can be provided on the core sheets or in the laminate films applied onto the core sheets.

In further examples the document of the current invention can be made machine readable by the introduction of detectable materials in any of the layers previously described (particularly one or more of the adhesive layers) or by the introduction of separate machine-readable layers. Detectable materials that react to an external stimulus include but are not limited to fluorescent, phosphorescent, infrared absorbing, thermochromic, photochromic, magnetic, electrochromic, conductive and piezochromic materials.

1. A method of producing documents of value, the method comprising:
providing a single lamina or multi-laminate sheet carrying data relating to a plurality of documents of value laterally spaced apart on the same sheet;
selecting the shape of at least part of the edge of each document using the data relating to the said document; and operating a cutting tool to cut out each document of value from the sheet by cutting along the edge of each document of value such that said at least part of the edge has the selected shape.

2. A method according to claim 1, wherein the selecting step includes reading said data from the sheet.

3. A method according to claim 1, wherein the selecting step
includes accessing a store of different edge shapes and selecting the edge shape corresponding to said data.

4. A method according to claim 1, wherein the sheet is
also provided with security indicia.

5. A method according to claim 4, wherein the same security indicia is
provided for each document of value.

6. A method according to claim 1, wherein at least two
of the documents of value are provided with different data associated with the respective, different edge shapes.

7. A method according to claim 1, wherein at least two
of the documents of value have different edge shapes comprising different corner shapes, differently shaped, oriented and/or positioned edge indents or notches, one having an edge indent and one not having an edge indent, polygonal shapes with the polygons having different numbers of edges or multiple edge indents or notches of different shapes and/or orientation.

8. A method according to claim 7, wherein at least one document of value is
one of a series of documents of value, each member of the series having a different pattern of edge notches.

9. A method according to claim 1, wherein said data is
data relating to the type of document of value.

10. A method according to claim 9, wherein the type of document of value is
chosen from the group comprising ID cards, driving licences, credit cards, debit
cards, certificates of authenticity, passports and banknotes.

11. A method according to claim 1, wherein said data is
data relating to the holder of the document, including at least one of nationality, age, country
of residence and biometric data.

12. A method according to claim 1, wherein said data
relating to said document is provided as printed data, or machine readable data,
including at least one of a RFID chip and magnetic code.

13. A method according to claim 1, wherein said data
relating to said document is readable to the naked eye.

14. A method according to claim 1, wherein the security
data comprises a security pattern, on the sheet.

15. A method according to claim 1, wherein the cutting
tool is one of a laser, water jet, air jet, or knife.

16. A document of value which has been manufactured using a method
of producing documents of value, the method comprising
providing a single lamina or multi-laminate sheet carrying data relating to a plurality of documents of value laterally spaced apart on the same sheet;
selecting the shape of at least part of the edge of each document using the data relating to the document; and operating a cutting tool to cut out each document of value from the sheet by cutting along the edge of each document of value such that said at least part of the edge has the selected shape.

17. A printed sheet carrying data relating to a plurality of documents of value
which are to be formed with different edge shapes when cut from the sheet.
